(19) United States
(12) Patent Application Publication
(10) Pub. No.: US 2023/0296806 A1
(43) Pub. Date: Sep. 21, 2023

(54) METASURFACE OPTICAL DEVICE AND FABRICATION METHOD

(71) Applicant: Shphotonics Ltd, Suzhou (CN)

(72) Inventors: Bing QIU, Suzhou (CN); Lei SUN, Suzhou (CN)

(21) Appl. No.: 18/182,639

(22) Filed: Mar. 13, 2023

(30) Foreign Application Priority Data
Mar. 15, 2022 (CN) 202210253719.0

(51) Int. Cl. G02B 1/00; B82Y 20/00; B82Y 40/00

(52) U.S. Cl. CPC G02B 1/002; B82Y 20/00; B82Y 40/00

(57) ABSTRACT

A metasurface optical device includes a substrate and a plurality of nano-pillars disposed at an end surface of the substrate. The plurality of nano-pillars is made of at least two kinds of materials, and dispersion coefficients of the at least two kinds of materials compensate or cancel each other or are configured to realize a pre-determined function.

### CROSS-REFERENCE TO RELATED APPLICATION

This application claims priority to Chinese Application No. 202210253719.0, filed on Mar. 15, 2022, the entire content of which is incorporated herein by reference.

### TECHNICAL FIELD

The present disclosure relates to the metasurface technology and, in particular, to a metasurface optical device and a method of fabrication the metasurface optical device.

### BACKGROUND

Metasurface optical devices are widely used in the field of optical design. Through metasurface design, lenses, polarization devices, optical computing, lidars, etc. can be realized. Metasurface optical devices can replace almost all existing optical devices.

Ordinary metasurface optical devices are often affected by structural diffraction dispersion. Light of different wavelengths have different diffraction directions when passing through the metasurface optical devices, resulting in a dispersion phenomenon. Existing methods for reducing the dispersion often include the following three categories. In the first category, nano-pillars formed on the surface of a metasurface optical device are made taller to cover a larger range of phase change and reduce the dispersion. However, a high aspect ratio makes it difficult to fabricate the metasurface optical device and other limitations exist in the fabrication process. In the second category, the metasurface optical device and existing devices are combined or integrated, where the existing devices are used to eliminate the dispersion phenomenon. However, the combination or integration increases complexity of a resulted optical system and reduces efficiency. Thus, this approach is often avoided in an optical design. In the third category, the metasurface optical device is designed to have a long focal depth. A calculation processing may be performed post-imaging to reduce the dispersion. However, the algorithm used in the calculation processing is often complicated and time consuming, and the metasurface optical device having the long focal depth often has low focusing efficiency. Therefore, the existing methods for reducing the dispersion are difficult to implement and cause undesired trade-offs.

### SUMMARY

One aspect of the present disclosure provides a metasurface optical device. The metasurface optical device includes a substrate and a plurality of nano-pillars disposed at an end surface of the substrate. The plurality of nano-pillars are made of at least two kinds of materials, and dispersion coefficients of the at least two kinds of materials compensate or cancel each other or are configured to realize a pre-determined function.

Another aspect of the present disclosure provides a method of fabricating a metasurface optical device. The fabrication method includes: forming a first material on an end surface of a substrate; etching a portion of the first material to expose a portion of the end surface of the substrate; forming a second material, the second material and the first material being arranged side by side in a direction parallel to the end surface of the substrate or being stacked in a direction perpendicular to the end surface of the substrate, a dispersion coefficient of the second material and a dispersion coefficient of the first material compensating each other; and etching the second material and the first material to obtain a plurality of nano-pillars.

Another aspect of the present disclosure includes a method of fabricating a metasurface optical device. The fabrication method includes: forming a sacrificial material on an end surface of a substrate; etching a portion of the sacrificial material to expose a portion of the end surface of the substrate to obtain at least two columnar spaces; forming different kinds of nano-materials in the at least two columnar spaces, such that the nano-materials in different columnar spaces are different, or at least one columnar space contains at least two kinds of nano-materials stacked, dispersion coefficients of different kinds of nano-materials compensating each other; and etching the second material and the first material to obtain a plurality of nano-pillars.

### BRIEF DESCRIPTION OF THE DRAWINGS

FIG. 1 is a schematic structural diagram of an exemplary nano-pillar structure according to some embodiments of the present disclosure;

FIG. 2 is a schematic structural diagram of another exemplary nano-pillar structure according to some embodiments of the present disclosure;

FIG. 3 is a schematic structural diagram of another exemplary nano-pillar structure according to some embodiments of the present disclosure;

FIG. 4 is a schematic structural diagram of another exemplary nano-pillar structure according to some embodiments of the present disclosure;

FIG. 5 shows a process flow of an exemplary method of fabricating a metasurface optical device according to some embodiments of the present disclosure;

FIG. 6 shows a process flow of another exemplary method of fabricating a metasurface optical device according to some embodiments of the present disclosure;

FIG. 7 shows a process flow of another exemplary method of fabricating a metasurface optical device according to some embodiments of the present disclosure; and

FIG. 8 shows a process flow of another exemplary method of fabricating a metasurface optical device according to some embodiments of the present disclosure.

### DETAILED DESCRIPTION OF THE EMBODIMENTS

In the following, some example embodiments are described. As those skilled in the art would recognize, the described embodiments can be modified in various different manners, all without departing from the spirit or scope of the present disclosure. Accordingly, the drawings and descriptions are illustrative in nature and not limiting.

In the present disclosure, terms such as “first,” “second,” and “third” can be used to describe various elements, components, regions, layers, and/or parts. However, these elements, components, regions, layers, and/or parts should not be limited by these terms. These terms are only used to distinguish one element, component, region, layer, or part from another element, component, region, layer, or layer. Therefore, a first element, component, region, layer, or part discussed below can also be referred to as a second element, component, region, layer, or part, which does not constitute a departure from the teachings of the present disclosure.

A term specifying a relative spatial relationship, such as “below,” “beneath,” “lower,” “under,” “above,” or “higher,” can be used in the disclosure to describe the relationship of one or more elements or features relative to other one or more elements or features as illustrated in the drawings. These relative spatial terms are intended to also encompass different orientations of the device in use or operation in addition to the orientation shown in the drawings. For example, if the device in the a drawing is turned over, an element described as “beneath,” “below,” or “under” another element or feature would then be “above” the other element or feature. Therefore, an example term such as “beneath” or “under” can encompass both above and below. Further, a term such as “before,” “in front of,” “after,” or “subsequently” can similarly be used, for example, to indicate the order in which light passes through the elements. A device can be oriented otherwise (e.g., being rotated by 90 degrees or being at another orientation) while the relative spatial terms used herein still apply. In addition, when a layer is referred to as being “between” two layers, it can be the only layer between the two layers, or there can be one or more intervening layers.

Terminology used in the disclosure is for the purpose of describing the embodiments only and is not intended to limit the present disclosure. As used herein, the terms “a,” “an,” and “the” in the singular form are intended to also include the plural form, unless the context clearly indicates otherwise. Terms such as “comprising” and/or “including” specify the presence of stated features, entities, steps, operations, elements, and/or parts, but do not exclude the existence or addition of one or more other features, integers, steps, operations, elements, parts, and/or combinations thereof. As used herein, the term “and/or” includes any and all combinations of one or more of the listed items. The phrases “at least one of A and B” and “at least one of A or B” mean only A, only B, or both A and B.

When an element or layer is referred to as being “on,” “connected to,” “coupled to,” or “adjacent to” another element or layer, the element or layer can be directly on, directly connected to, directly coupled to, or directly adjacent to the other element or layer, or there can be one or more intervening elements or layers. In contrast, when an element or layer is referred to as being “directly on,” “directly connected to,” “directly coupled to,” or “directly adjacent to” another element or layer, then there is no intervening element or layer. “On” or “directly on” should not be interpreted as requiring that one layer completely covers the underlying layer.

In the disclosure, description is made with reference to schematic illustrations of example embodiments (and intermediate structures). As such, changes of the illustrated shapes, for example, as a result of fabrication techniques and/or tolerances, can be expected. Thus, embodiments of the present disclosure should not be interpreted as being limited to the specific shapes of regions illustrated in the drawings, but are to include deviations in shapes that result, for example, from fabrication. Therefore, the regions illustrated in the drawings are schematic and their shapes are not intended to illustrate the actual shapes of the regions of the device and are not intended to limit the scope of the present disclosure.

Unless otherwise defined, all terms (including technical and scientific terms) used herein have the same meaning as commonly understood by those of ordinary skill in the art to which this disclosure belongs. Terms such as those defined in commonly used dictionaries should be interpreted to have meanings consistent with their meanings in the relevant field and/or in the context of this disclosure, unless expressly defined otherwise herein.

As used herein, the term “substrate” can refer to the substrate of a diced wafer, or the substrate of an un-diced wafer. Similarly, the terms “chip” and “die” can be used interchangeably, unless such interchange would cause conflict. The term “layer” can include a thin film, and should not be interpreted to indicate a vertical or horizontal thickness, unless otherwise specified.

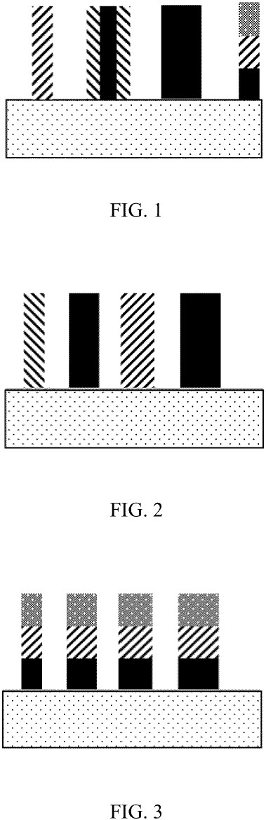

FIGS. 1-4 are schematic structural diagrams of exemplary nano-pillar structures according to some embodiments of the present disclosure. As shown in FIGS. 1-4, a metasurface optical device includes a substrate and a plurality of nano-pillars formed on a surface of the substrate. The plurality of nano-pillars are made of at least two kinds of materials. Dispersion coefficients of the at least two kinds of materials compensate or cancel each other or are combined according to a pre-determined function.

In some embodiments, the substrate is often a wafer. A material of the substrate includes but is not limited to the wafer, and may be another material. The dispersion coefficients of the at least two kinds of materials may be opposite to each other or may be identical. When the dispersion coefficients of the at least two kinds of materials are identical, a lens design of the metasurface optical device including a same nanomaterial may be relied upon to reduce a dispersion effect. This is similar to a doublet lens in traditional lenses, where signs of the dispersion coefficients of the two lenses are identical, and chromatic aberration is reduced by sizes of the dispersion coefficients and a radius of curvature.

In some embodiments, as shown in FIG. 1, according to a function to be achieved by the meta surface optical device, a manner of arranging the plurality of nano-pillars can be calculated from a database. Nano-pillars can be arranged alternately or periodically. Two different nano-pillars correspond to two different optical functions. Differences in the optical functions of the nano-pillars mainly depends on shapes and materials of the nano-pillars. Different pre-determined functions can be achieved through different kinds of materials, different structures, different positions, different shapes, different periods, different arrangements, and different heights, etc.

In some embodiments, the plurality of nano-pillars are arranged on the substrate according to the array pre-configured in the database. A light beam can be irradiated from any angle to pass through the metasurface optical device before exiting. After the light beam enters the metasurface optical device, the light beam passes through the plurality of nano-pillars of different kinds of materials and different shapes. Nano-pillars of a certain material may be optimized for a certain wavelength of light to reduce the dispersion or to change refraction and diffraction effects. Different refractive indices and dispersion coefficients of different kinds of materials may be combined in various ways to reduce or increase the dispersion of the incident light, thereby achieving light convergence, divergence, transmission, reflection, and polarization, etc.

The present disclosure provides a metasurface optical device. The metasurface optical device includes nano-pillars made of at least two kinds of materials. Different kinds of materials have different refractive indices and different dispersion coefficients. When light passes through the nano-pillars, the light is subject to different refraction and diffraction effects. Through various arrangements and combinations of the nano-pillars of different kinds of materials, a wavefront of an outgoing light is modulated, including but not limited to reducing or increasing the chromatic aberration, the polarization, the amplitude, and the frequency, etc. The metasurface optical device provided by the present disclosure may be used for chromatic aberration adjustment, imaging, spectrum control, display devices, electro-optical integration, and optical computing, etc. Compared to a metasurface optical device made of one single material, the metasurface optical device made of the at least two kinds of materials achieves the pre-determined function more effectively.

In some embodiments, the plurality of nano-pillars made of at least two kinds of materials includes any nano-pillar of a first part of the plurality of nano-pillars being made of a same material or a first material and any nano-pillar of a second part of the plurality of nano-pillars being made of another same material different from the first material.

In some embodiments, the first part of the plurality of nano-pillars includes at least one nano-pillar. A quantity of the first part of the plurality of nano-pillars is determined according to the functional design of the metasurface optical device. Each nano-pillar of first part of the plurality of nano-pillars is made of the same material. The first part of the plurality of nano-pillars and the second part of the plurality of nano-pillars are made of different kinds of materials.

In some embodiments, any nano-pillar of the second part of the plurality of nano-pillars is made of one single material, which is different from the material of the first part of the plurality of nano-pillars.

In some embodiments, the second part of the plurality of nano-pillars includes at least one nano-pillar. A quantity of the second part of the plurality of nano-pillars is determined according to the functional design of the metasurface optical device. Each nano-pillar of second part of the plurality of nano-pillars is made of a same material. All of the second part of the plurality of nano-pillars may be made of another same material. The first part of the plurality of nano-pillars and the second part of the plurality of nano-pillars are arranged in various ways. For example, nano-pillars made of different kinds of materials may be arranged alternately. In another example, the nano-pillars in one area are made of one material, and the nano-pillars in another area are made of another material. As shown in FIG. 2, the first part of the plurality of nano-pillars is made of one material, and the second part of the plurality of nano-pillars is made of another material. The first part of the plurality of nano-pillars and the second part of the plurality of nano-pillars may be arranged differently.

In some embodiments, any nano-pillar of the second part of the plurality of nano-pillars includes at least two kinds of materials.

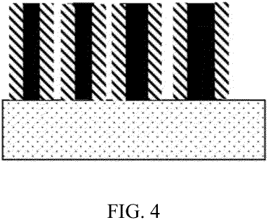

In some embodiments, as shown in FIG. 3 and FIG. 4, each nano-pillar of second part of the plurality of nano-pillars is made of at least two kinds of materials. Different nano-pillars in the second part may be made of different kinds of materials or may be made of the same materials. Similarly, the first part of the plurality of nano-pillars and the second part of the plurality of nano-pillars may be arranged in various ways. For example, the nano-pillars made of different kinds of materials may be arranged alternately. In another example, the nano-pillars in one area are made of one material, and the nano-pillars in another area are made of another material.

In some embodiments, the plurality of materials being made of at least two kinds of materials includes any nano-pillar of the plurality of nano-pillars being made of at least two kinds of materials.

In some embodiments, as shown in FIG. 3 and FIG. 4, each nano-pillar of plurality of nano-pillars disposed at the metasurface optical device includes at least two kinds of materials. Each nano-pillar may be made of different kinds of materials or may be made of exactly same materials. Nano-pillars of different structures may be arranged in various ways according to the pre-determined function.

In some embodiments, when the plurality of nano-pillars are made of the at least two kinds of materials, the plurality of nano-pillars include: nano-pillars formed by layering the at least two kinds of materials in a direction perpendicular to an end surface of the substrate, or nano-pillars formed by combining the at least two kinds of materials in the direction perpendicular to the end surface of the substrate.

In some embodiments, when a non-pillar is made of at least two kinds of materials, different kinds of materials may be arranged in the following two examples. In the first example, as shown in FIG. 3, the different kinds of materials are arranged sequentially in the direction perpendicular to the end surface of the substrate. An arrangement sequence of the different kinds of materials is determined according to an optical function of each nano-pillar. In the second example, as shown in FIG. 4, each of the different kinds of materials is arranged vertically on the end surface of the substrate. An arrangement sequence of the different kinds of materials is determined according to the optical function of each nano-pillar. An outer material of the plurality of nano-pillars may be a same material and may be different from an inner material of the plurality of nano-pillars. The outer material and the inner material of each nano-pillar may be arranged in a sandwich structure, or may be arranged in a circularly-enclosed structure, that is, the outer material surrounds the inner material.

In some embodiments, the plurality of nano-pillars include the nano-pillars formed by layering the at least two kinds of materials in the direction perpendicular to the end surface of the substrate, or the nano-pillars formed by combining the at least two kinds of materials in the direction perpendicular to the end surface of the substrate. These include the at least two kinds of materials being arranged sequentially in the direction perpendicular to the end surface of the substrate, or any of the at least two kinds of materials forming a cladding layer and remaining materials forming a pillar core surrounded by the cladding layer. The pillar core may be made of one single material, or may be made of at least two kinds of materials formed layer by layer in the direction perpendicular to the end surface of the substrate.

In some embodiments, when a nano-pillar is made of at least two kinds of materials, and the at least two kinds of materials are arranged in combination in the direction perpendicular to the end surface of the substrate. As shown in FIG. 4, each nano-pillar includes a cladding layer and a pillar core. The cladding layer includes one single material, which is different from that of the pillar core. The pillar core may include one single material or different kinds of materials. The pillar core may be included in any nano-pillar in FIG. 2 and FIG. 3. However, the pillar core may not be limited to what have been shown in FIG. 2 and FIG. 3. The cladding layer may include two parts arranged on two sides of the pillar core respectively to form a sandwich structure, or may be a circular structure arranged to surround the pillar core, or may be a circular structure with one or more gaps arranged to surround the pillar core. The structure of each nano-pillar is not limited by the present disclosure.

In some embodiments, light absorption of the at least two kinds of materials is less than a preset value, and refractive indices of the at least two kinds of materials are different.

In some embodiments, all materials may not absorb light or the absorption may be less than the preset value. Because the materials do not absorb light, the incident light and the outgoing light may not be affected.

In some embodiments, a shape of any material of any nano-pillar of the plurality of nano-pillars includes: a circle, a square, a star, a ring, a pentagon, or a hexagon.

In some embodiments, the shape of each nano-pillar is determined according to the function of the metasurface optical device. When the nano-pillar includes multiple layered materials, each material layer can correspond to a different shape. For example, a nano-pillar has two layers and may have a structure including a cylinder at the bottom and a square column at the top, and another nano-pillar may have a structure including a pentagon at the bottom and a hexagon at the top. The shape of nano-pillars includes but is not limited to a circle, a square, a star, a ring, a pentagon, or a hexagon. The shape of each nano-pillar is determined according to the difficulty of the fabrication process and the pre-determined function. Nano-pillars of different shapes are diversely arranged.

A metasurface optical device adopting the structure described in the embodiments of the present disclosure uses at least two kinds of materials to form all the nano-pillars, and the refractive index and dispersion coefficient of different kinds of materials are different. When light passes through the plurality of nano-pillars, the light is subject to different refraction and diffraction effects. Through different kinds of materials, different structures, different positions, different shapes, different periods, and different arrangements, etc. of the plurality of nano-pillars, the wavefront of the outgoing light is modulated, including but not limited to reducing or increasing the chromatic aberration, modulating the polarization, the amplitude, and the frequency, etc., to achieve different pre-determined functions.

Corresponding to the metasurface optical device shown in FIG. 1 to FIG. 4, the present disclosure also provides a corresponding fabrication method. The method for fabricating the corresponding metasurface optical device will be described in detail below.

In some embodiments, the present disclosure provides an exemplary fabrication method 100 of a metasurface optical device, and the fabrication method 100 includes the following processes. A first material is formed over an end surface of a substrate such that the first material covers the entire end surface of the substrate. A portion of the first material is etched to expose the end surface of the substrate, retaining a remaining portion of the first material. A second material is formed, such that the second material and the first material are arranged side by side in a direction parallel to the end surface of the substrate or stacked in a direction perpendicular to the end surface of the substrate. A dispersion coefficient of the second material and a dispersion coefficient of the first material compensate each other. The second material and the first material are etched to obtain a plurality of nano-pillars. The first material and the second material can be formed by, e.g., plating.

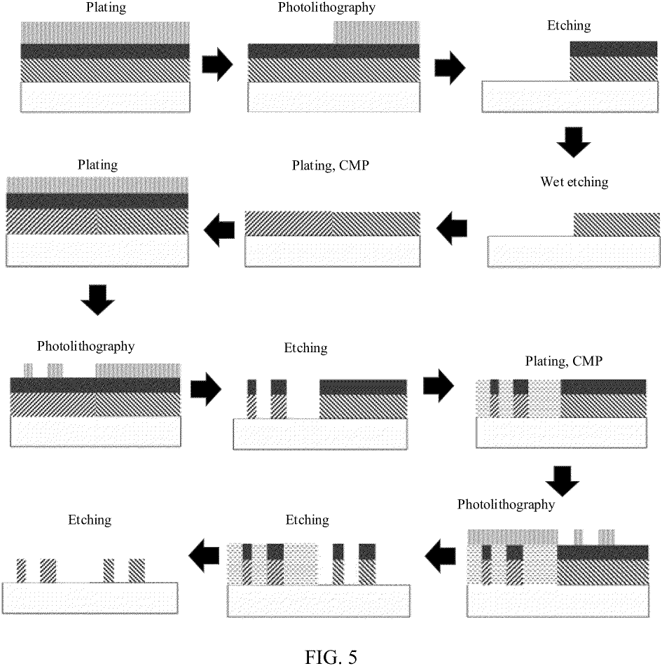

In some embodiments, the process of forming the second material in the fabrication method 100 may include: forming the second material on the end surface of the substrate obtained by etching, such that a thickness of the second material is the same as a thickness of the first material, and obtaining a first material film arranged side by side with a second material film, as shown in FIG. 5.

FIG. 5 shows a process flow of an exemplary method of fabricating a metasurface optical device according to some embodiments of the present disclosure. As shown in FIG. 5, the method includes the following processes. The first material is formed on the substrate such that the first material covers the entire end surface of the substrate. A sacrificial material and a photolithographic material are formed on the first material. Certain unnecessary materials are etched according to pre-configured arrangement information of the plurality of nano-pillars. The second material is then formed, and another sacrificial material and another photolithographic material are formed on the first material and the second material. Certain unnecessary materials are etched again according to the pre-configured arrangement information of the plurality of nano-pillars. To protect already formed nano-pillars, another sacrificial medium needs to be formed between the nano-pillars. After all of the plurality of nano-pillars are etched and formed, unnecessary material medium is etched away. Then, an optical device shown in FIG. 2 is obtained. Each nano-pillar of the obtained optical device is made of one single material, and different nano-pillars may be made of different kinds of materials.

The fabrication method shown in FIG. 5 is only one embodiment of the present disclosure. In some other embodiments, the technical solution of the present disclosure also provides other fabrication methods. For example, forming the second material in the fabrication method 100 may further include: forming a sacrificial material or a filling material on the end surface of the substrate obtained by etching, such that the thickness of the sacrificial material or the filled material is the same as the thickness of the first material, and forming the second material on the end surface formed with the sacrificial material or the filling material and the first material, to obtain the first material film and the second material film stacked in the direction perpendicular to the end surface of the substrate.

In some embodiments, etching the second material and the first material to obtain the plurality of nano-pillars includes: etching a portion of the end surface of the substrate coated with the sacrificial material to obtain the plurality of nano-pillars.

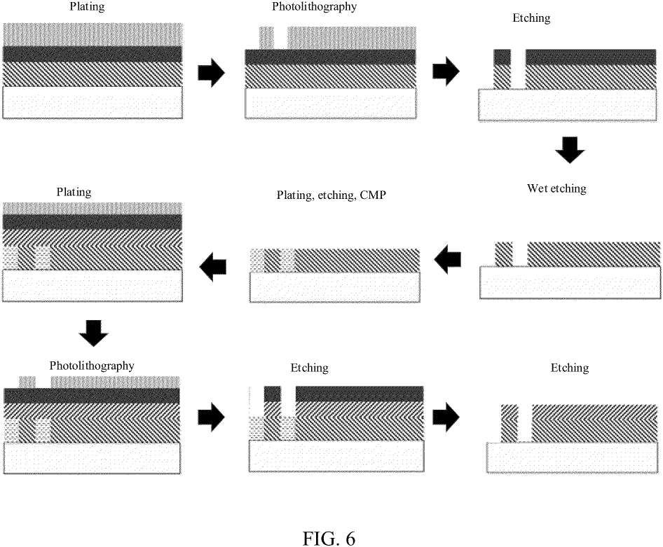

FIG. 6 shows a process flow of another exemplary method of fabricating a metasurface optical device according to some embodiments of the present disclosure. As shown in FIG. 6, the fabrication method includes the following processes. The first material is formed on the substrate, such that the first material covers the entire end surface of the substrate. The sacrificial material and the photolithographic material are coated on the first material. Certain unnecessary materials are etched away according to the pre-configured arrangement information of the plurality of nano-pillars. The sacrificial material or filling material is formed among the plurality of nano-pillars. The second material is formed. The sacrificial material and the photolithographic material are formed on the second material. The sacrificial material is etched away according to the pre-configured arrangement information of the plurality of nano-pillars. The filling material is filled to protect mechanical stability of the plurality of nano-pillars and to prevent the plurality of nano-pillars from being externally damaged. The filling material is retained to obtain the pre-configured plurality of nano-pillars. Then, each nano-pillar of plurality of nano-pillars on the optical device is made of the at least two kinds of materials. Different kinds of materials are sequentially arranged along the direction perpendicular to the end surface of the substrate for the metasurface optical device as shown in FIG. 3.

Embodiments of the fabrication method 100 are intended to be illustrative and the present disclosure should not be limited by the description thereof. In some other embodiments, the fabrication method may be implemented in other ways.

The present disclosure also provides a method 200 of fabricating a metasurface optical device. The fabrication method 200 includes the following processes. The sacrificial material is formed on the end surface of the substrate, such that the sacrificial material covers the entire end surface of the substrate. Part of the sacrificial material is etched to expose the end surface of the substrate to obtain at least two columnar spaces. Different kinds of nano-materials are formed in the at least two columnar spaces, such that the nano-materials in different columnar spaces are different, or at least one columnar space contains at least two kinds of nano-materials stacked, and the dispersion coefficients of the different kinds of nano-materials compensate with each other. The remaining sacrificial material on the end surface of the substrate is etched to obtain the plurality of nano-pillars.

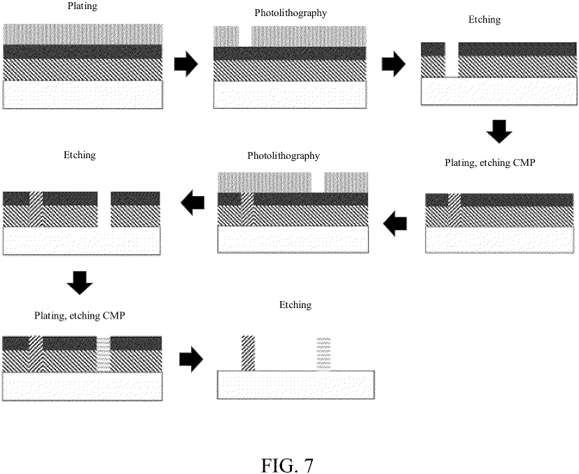

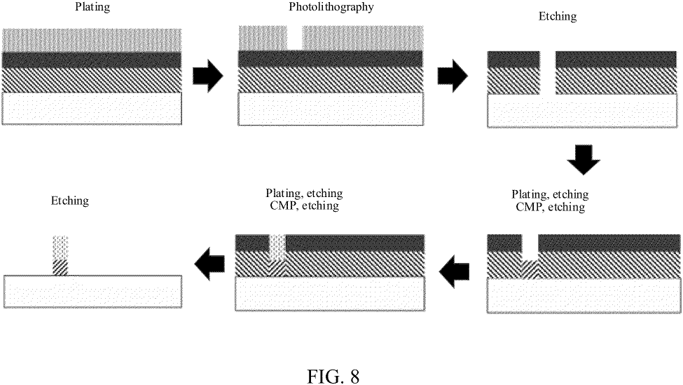

FIG. 7 shows a process flow of another exemplary method of fabricating a metasurface optical device according to some embodiments of the present disclosure. As shown in FIG. 7, the fabrication method includes the following processes. The sacrificial material is formed on the end surface of the substrate, such that the sacrificial material covers the entire end surface of the substrate. The photolithographic material is coated on the sacrificial material. Certain unnecessary materials are etched according to pre-configured arrangement information of the plurality of nano-pillars. The nano-materials are formed in the columnar spaces obtained by etching, and the photolithographic material is formed over the nano-materials. Different kinds of nano-materials are formed in different columnar spaces according to the pre-configured arrangement information of the plurality of nano-pillars. Certain unnecessary materials are etched away again to obtain the plurality of nano-pillars. Then, the optical device as shown in FIG. 2 is obtained. Each nano-pillar on the optical device is made of one single material, and different nano-pillars are made of different kinds of materials.

In some embodiments, the fabrication method 200 may also be realized as the process flow shown in FIG. 8. As shown in FIG. 8, the fabrication method 200 includes the following processes. The sacrificial material is formed on the end surface of the substrate, such that the sacrificial material covers the entire end surface of the substrate. The photolithographic material is formed on the sacrificial material. Certain unnecessary materials are etched away according to the pre-configured arrangement information of the plurality of nano-pillars. At least two different kinds of nano-materials are sequentially formed in the direction perpendicular to the end surface of the substrate in the columnar spaces obtained by etching, such that the at least two kinds of nano-materials are stacked to obtain the plurality of nano-pillars. Then, each nano-pillar on the obtained optical device includes at least two kinds of nano-materials, and different kinds of materials are sequentially arranged in the direction perpendicular to the end surface of the substrate, such that the optical device shown in FIG. 3 is obtained.

In some embodiments, the plurality of nano-pillars obtained in the fabrication method 100 and the fabrication method 200 may also be combined with a self-aligned double patterning technology to obtain the structure shown in FIG. 4.

The fabrication method 100 and the fabrication method 200 provided in the present disclosure are merely intended to be illustrative, and do not constitute limitations to the technical solutions of the embodiments of the present disclosure. The specific implementation of the technical solutions of the embodiments of the present disclosure includes but is not limited to the above-described embodiments. In an actual implementation scenario, other specific implementation manners may also be adopted according to the structure of the metasurface optical device disclosed herein, which will not be repeated here.

In the embodiments of the present disclosure, the metasurface optical device and its fabrication method are provided. At least two kinds of materials are used to form all the nano-pillars, and the refractive indices and dispersion coefficients of different kinds of materials are different. When passing through the plurality of nano-pillars, the light is subject to different refraction and diffraction effects. Through different kinds of materials, different structures, different positions, different shapes, different periods, and different arrangements, etc. of the plurality of nano-pillars, the wavefront of the outgoing light is modulated, including but not limited to reducing or increasing the chromatic aberration, modulating the polarization, the amplitude, and the frequency, etc., to achieve different pre-determined functions.

Several different embodiments or examples are described in the present disclosure. These embodiments or examples are exemplary and are not intended to limit the scope of the present disclosure. Those skilled in the art can conceive of various modifications or substitutions based on the disclosed contents, and such modifications and substitutions should be included in the scope of the present disclosure. A true scope and spirit of the invention is indicated by the following claims.

What is claimed is:

1. A metasurface optical device comprising:
a substrate; and
a plurality of nano-pillars disposed at an end surface of the substrate;
wherein the plurality of nano-pillars are made of at least two kinds of materials, and dispersion coefficients of the at least two kinds of materials compensate or cancel each other or are configured to realize a pre-determined function.

2. The metasurface optical device of claim 1, wherein the plurality of nano-pillars include:
a first nano-pillar entirely made of a first material of the at least two kinds of materials; and
a second nano-pillar including a second material of the at least two kinds of materials, the second material being different from the first material.

3. The metasurface optical device of claim 2, wherein:
the second nano-pillar is made of a single material of the at least two kinds of materials that is different from the first material.

4. The metasurface optical device of claim 2, wherein:
the second nano-pillar is made of the at least two kinds of materials.

5. The metasurface optical device of claim 1, wherein:
each of the plurality of nano-pillars includes the at least two kinds of materials.

6. The metasurface optical device of claim 1, wherein:
one nano-pillar of the plurality of nano-pillars includes the at least two kinds of materials arranged layer by layer in a direction perpendicular to the end surface of the substrate.

7. The metasurface optical device of claim 6, wherein:
the at least two kinds of materials are arranged sequentially in the direction perpendicular to the end surface of the substrate to form the one nano-pillars.

8. The metasurface optical device of claim 1, wherein:
one nano-pillar of the plurality of nano-pillars includes the at least two kinds of materials combined in a direction perpendicular to the end surface of the substrate.

9. The metasurface optical device of claim 8, wherein the one nano-pillar includes:
a cladding layer made of a first material of the at least two kinds of materials; and
a pillar core surrounded by the cladding layer and made of:
a second material of the at least two kinds of materials; or
the at least two kinds of materials formed layer by layer in the direction perpendicular to the end surface of the substrate.

10. The metasurface optical device of claim 1, wherein:
light absorptions of the at least two kinds of materials are less than a preset value; and
refractive indices of the at least two kinds of materials are different.

11. The metasurface optical device of claim 1, wherein:
a shape of any material of any nano-pillar of the plurality of nano-pillars includes a circle, a square, a star, a ring, a pentagon, or a hexagon.

12. A method of fabricating a metasurface optical device comprising:
forming a first material on an end surface of a substrate;
etching a portion of the first material to expose a portion of the end surface of the substrate;
forming a second material, the second material and the first material being arranged side by side in a direction parallel to the end surface of the substrate or being stacked in a direction perpendicular to the end surface of the substrate, a dispersion coefficient of the second material and a dispersion coefficient of the first material compensating each other; and
etching the second material and the first material to obtain a plurality of nano-pillars.

13. The method of claim 12, wherein forming the second material includes:
forming the second material on the exposed portion of the end surface of the substrate to a thickness same as a thickness of the first material, to obtain a first material film arranged side by side with a second material film.

14. The method of claim 12, wherein forming the second material includes:
forming a sacrificial material or a filling material on the end surface of the substrate after etching, a thickness of the sacrificial material or the filled material being same as a thickness of the first material; and
forming the second material on the end surface formed with the sacrificial material or the filling material and the first material, to obtain the first material film and the second material film stacked in the direction perpendicular to the end surface of the substrate.

15. The method of claim 14, wherein etching the second material and the first material to obtain the plurality of nano-pillars includes:
etching a portion of the end surface of the substrate formed with the sacrificial material to obtain the plurality of nano-pillars.

16. A method of fabricating a metasurface optical device comprising:
forming a sacrificial material on an end surface of a substrate;
etching a portion of the sacrificial material to expose a portion of the end surface of the substrate to obtain at least two columnar spaces;
forming different kinds of nano-materials in the at least two columnar spaces, such that the nano-materials in different columnar spaces are different, or at least one columnar space contains at least two kinds of nano-materials stacked, dispersion coefficients of different kinds of nano-materials compensating each other; and
etching the second material and the first material to obtain a plurality of nano-pillars.
